(19) United States
(12) Patent Application Publication
(10) Pub. No.: US 2007/0279937 A1
(43) Pub. Date: Dec. 6, 2007

(54) BACKLIGHT MODULE

(75) Inventors: Meng-Jia Hsiao, Taichung County (TW); Chih-Kuang Chen, Kaohsiung City (TW); Kuo-Tung Huang, Taoyuan County (TW); Yu-Yen Hsu, Hsinchu County (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: AU OPTRONICS CORP., Hsinchu (TW)

(21) Appl. No.: 11/556,369

(22) Filed: Nov. 3, 2006

(30) Foreign Application Priority Data
Jun. 6, 2006 (TW) 95120002

(51) Int. Cl. F21V 7/04

(52) U.S. Cl. 362/613

(57) ABSTRACT

A backlight module includes a back bezel, at least two spot light sources, and a diffuser plate. The spot light sources are disposed on the back bezel. The diffuser is disposed above the back bezel and the spot light sources. The spot light sources are disposed at different locations along the thickness of the backlight module, or optical axes of the spot light sources are not parallel.

### BACKGROUND OF THE INVENTION

1. Field of the Invention

The invention relates to a backlight module, and in particular to a backlight module for a flat panel display.

2. Description of the Related Art

Recently lighting efficiency of light emitting diodes (LEDs) has been greatly improved. In the future, LEDs will be as good as or even superior to cold cathode fluorescent lamps (CCFLs), and thus widely used in various lighting devices, particularly in information display devices requiring high lighting quality and efficiency.

A conventional fluorescent lamp (e.g. CCFL) is a linear light source with no specific optical axis and radiation pattern. Thus, use of conventional light source is simple and easy with no need for complex design. However, a spot light source (e.g. LED) is packaged and powered differently than other conventional light sources. An LED has a special radiation pattern substantially axially symmetric, such that an imaginary optical axis of the LED can be determined. Furthermore, adjustment of the optical axis of an LED significantly influences the radiation patterns of the LED in space. It is therefore understood that efficient use of LEDs in a backlight module is based on a considerate optical design.

Generally, full width at half maximum (FWHM) measurement is used to assess the angular distribution of luminous intensity. Assuming that the maximum luminous intensity is A, the half-value angle is the angle at which the luminous intensity drops to A/2. LEDs can be classified into different types in accordance with their radiation patterns. For Example, a high-directional LED has a half-value angle in a range of 5°-20° (or even less than 5°), and is generally used for providing local illumination. An LED of standard type has a half-value angle in a range of 20°-45°, and is generally used as an indicating lamp. An LED of light-scattering type has a half-value angle in a range of 45°-90° (or even greater than 90°).

Lumileds Company of USA produces various LEDs of different radiation patterns including the batwing type as shown in FIG. 1A, the lambertian type as shown in FIG. 1B, the side-emitting type as shown in FIG. 1C, and others. Furthermore, an LED of collimated radiation pattern is provided in the industry. Selecting LEDs based on their radiation patterns to fit backlight modules is a difficult and important consideration.

Assuming that light is emitted from a backlight module in +Z direction, a location adjustment of LEDs must be performed on an XY plane since conventional backlight modules use a flat board as a base to carry the LEDs. Thus, the central brightness and light uniformity of the backlight module are adjusted only by changing the locations of LEDs in XY-plane. As a result, improvement of central brightness conflicts with that of light uniformity.

### BRIEF SUMMARY OF THE INVENTION

The invention provides a backlight module using LEDs as light sources. The backlight module includes a back bezel provided with a plurality of planar surfaces or a curved surface. Thus, not only the LEDs laid out on a horizontal plane but also the optical axes thereof can be adjusted. Improving on the conventional structure, the backlight module of the invention has an additional design parameter-the direction of the optical axis, such that both central brightness and light uniformity are improved without conflict.

A backlight module of the invention may include a back bezel, at least two spot light sources, and a diffuser plate. The spot light sources are disposed on the back bezel. The diffuser is disposed above the back bezel and the spot light sources. The spot light sources are disposed at different locations along the thickness of the backlight module.

Another backlight module of the invention may include a back bezel, at least two spot light sources, and a diffuser plate. The spot light sources are disposed on the back bezel. The diffuser is disposed above the back bezel and the spot light sources. The optical axes of the spot light sources are not parallel.

A flat panel display of the invention may include a display panel, a backlight module, and a shell surrounding the display panel and the backlight module. The backlight module includes a back bezel, at least two spot light sources, and a diffuser plate. The spot light sources are disposed on the back bezel. The diffuser is disposed above the back bezel and the spot light sources. The spot light sources are disposed at different locations along the thickness of the backlight module.

### BRIEF DESCRIPTION OF THE DRAWINGS

The invention can be more fully understood by reading the subsequent detailed description and examples with references made to the accompanying drawings, wherein:

FIGS. 1A, 1B, and 1C depict different radiation patterns of different light emitting diodes;

FIG. 2 is an exploded perspective diagram of a flat panel display;

FIG. 3 is an exploded perspective diagram of a backlight module in accordance with the invention;

FIGS. 4A-4H depict various exemplary embodiments of the back bezel of the backlight module in accordance with the invention; and

FIG. 5 depicts another example of the back bezel in accordance with the invention.

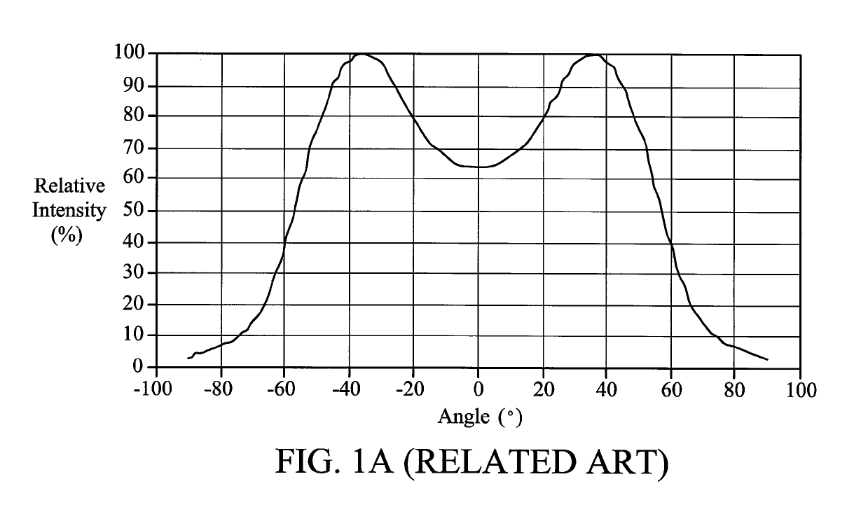

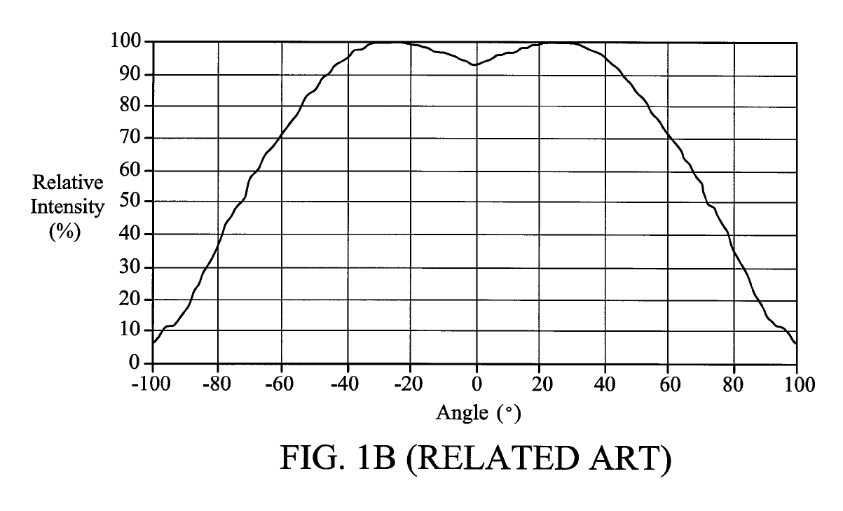

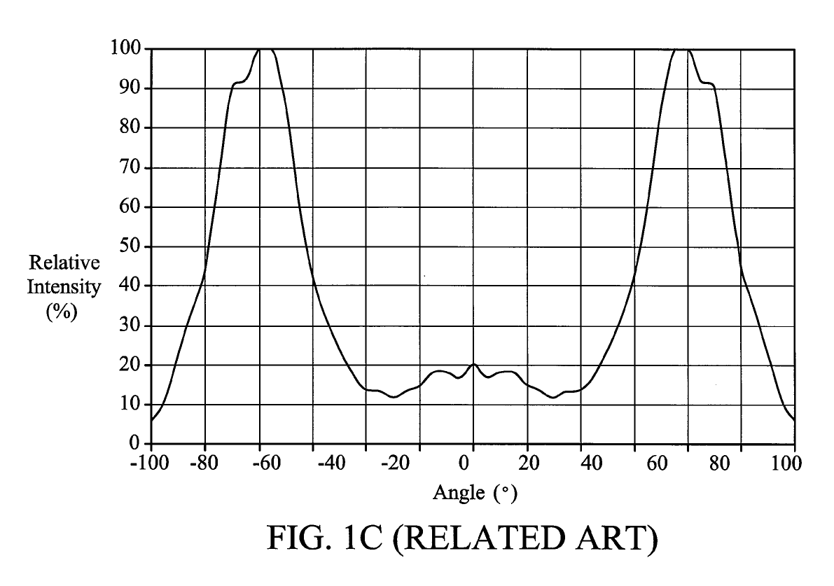

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

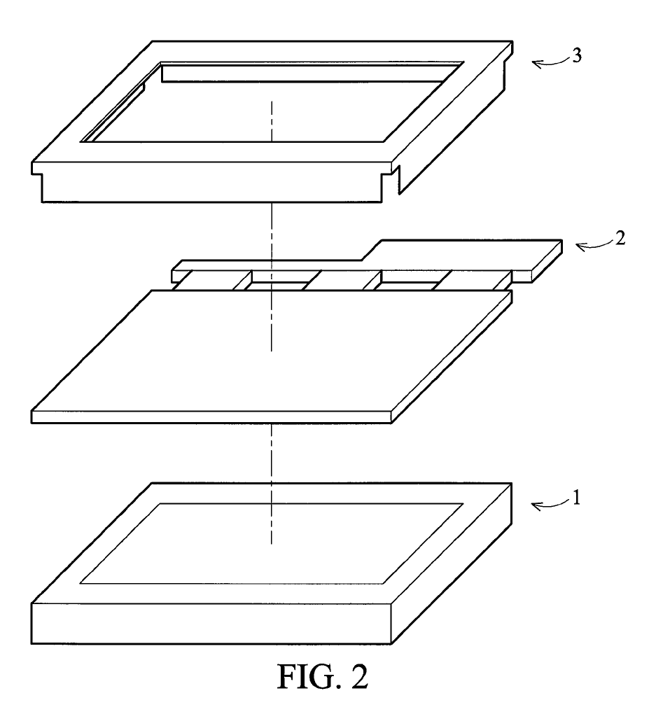

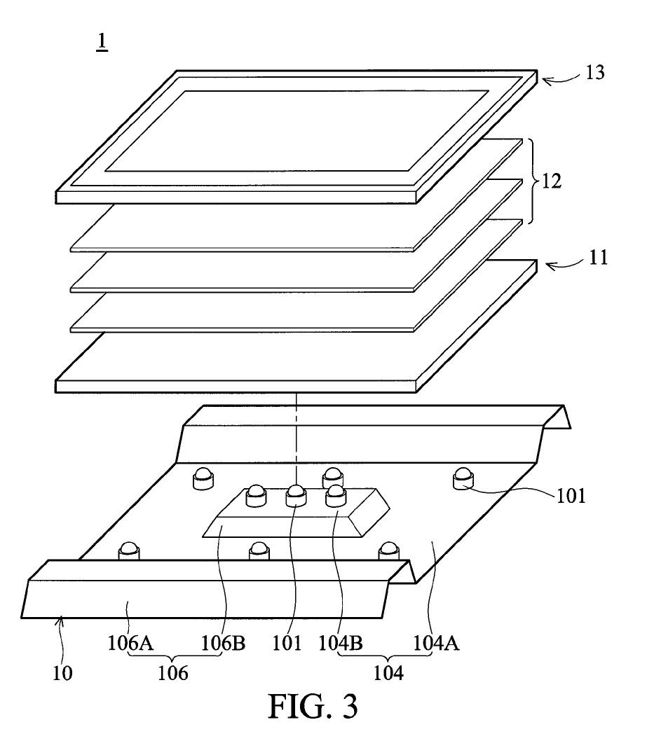

Referring to FIG. 2, a flat panel display (FPD) includes a backlight module 1, a display panel 2, and a shell 3 surrounding the backlight module 1 and the display panel 2. Referring to FIG. 3, the backlight module 1 includes a back bezel 10, a plurality of spot light sources 101, a frame 13, a diffuser plate 11, and other optical elements 12. The optical elements 12 may be optical films including a diffuser film, a prism film, a microstructure film, a brightness enhancement film, and/or other films capable of changing the optical characteristics of the light passing therethrough. The diffuser plate 11 is disposed above the back bezel 10 and the spot light sources 101. If necessary, additional optical elements may be provided between the back bezel 10 and the diffuser plate 11 to improve light utilization efficiency or provide proper light distribution as required. Other additional elements may be further provided therebetween to enhance structural strength of the backlight module or meeting other design requirements.

Referring to FIG. 3, a plurality of spot light sources 101 are provided on the back bezel 10. The spot light sources 101 are, for example, light-emitting diodes (LEDs) of different radiation patterns. The back bezel 10 includes a first part 104 with spot light sources 101 mounted thereon and a second part 106 with no spot light sources thereon. The second part 106 includes, for example, sidewalls 106A supporting the diffuser plate 11. The sidewalls 1 06A may have a U-shaped section as shown in FIG. 3, an L-shaped section, or a section in other shapes. Furthermore, the sidewalls 106A may be disposed around the first part 104, or on opposite sides of the first part 104 as shown in FIG. 3.

The first part 104 with light-emitting diodes (LEDs) mounted thereon includes two or more portions. FIG. 3 depicts an exemplary embodiment, wherein the first part 104 includes a first portion 104A and a second portion 104B arranged at different levels. Thus, light-emitting diodes (LEDs) on the first and second portions 104A and 104B are also at different levels. In other words, the LEDs on the first portion 104A and on the second portion 104B are disposed at different locations along the thickness of the backlight module 1. As shown in the figure, the second portion 104B is higher than and surrounded by the first portion 104A. A plurality of spot light sources 101 are respectively provided on the first portion 104A and the second portion 104B. The second part 106 further includes sidewalls 106B connected between the first and second portions 104A and 104B. The surfaces of the sidewalls 106B may be vertical, inclined, or even curved, depending on design requirements. The height of the sidewalls 106B can be changed in accordance with the optical characteristics of the spot light sources or design requirements, to meet required brightness, light uniformity, or light distribution.

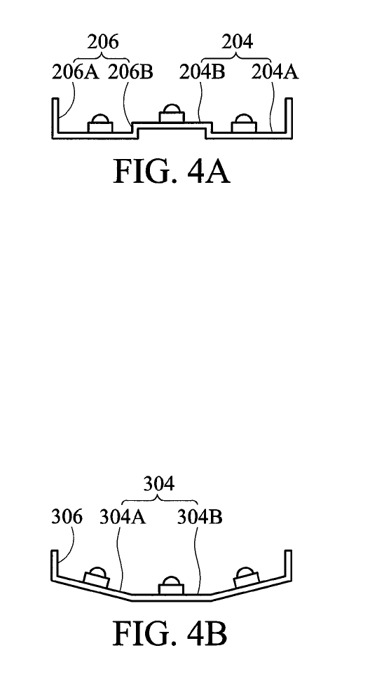

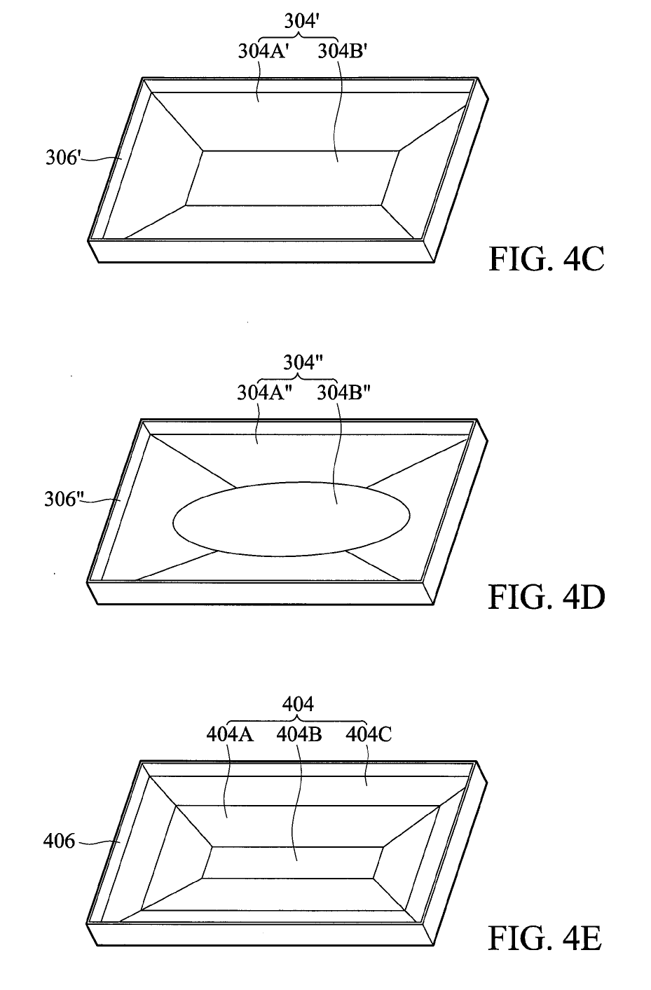

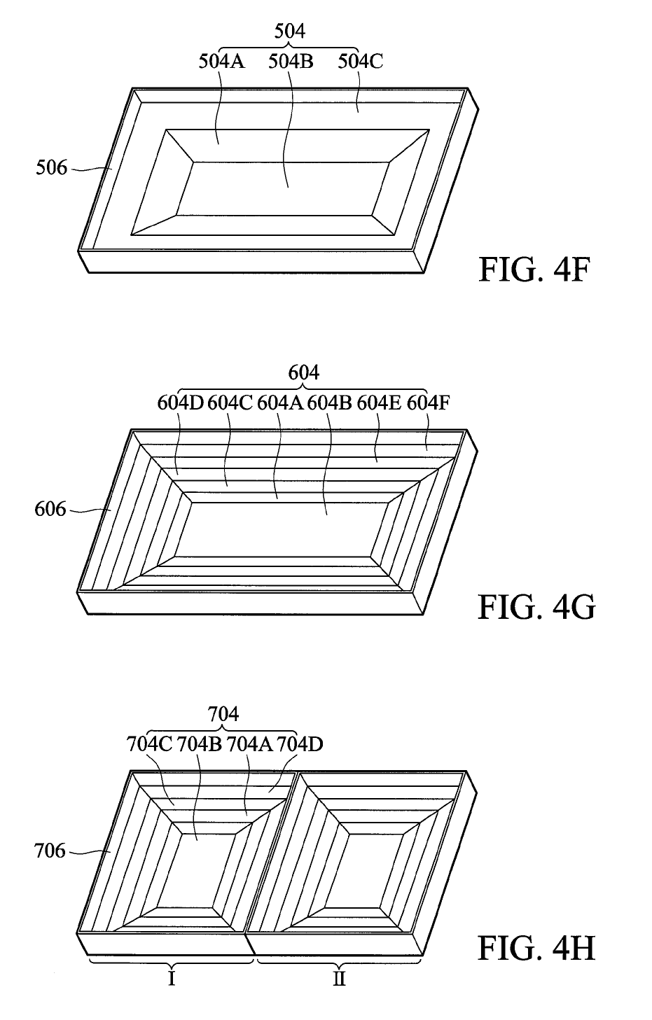

FIGS. 4A-4H depict various exemplary embodiments of the back bezel 10. For clarity, only three spot light sources 101 are shown in FIGS. 4A and 4B and no spot light sources are shown in FIGS. 4C-4H.

In FIG. 4A, the first part 204 includes a first portion 204A and a second portion 204B arranged at different levels. The second portion 204B is higher than and surrounded by the first portion 204A. It is understood, however, that the first part may include a plurality of first portions and a plurality of second portions. The first and second portions may be alternately arranged along the length or the width of the back bezel, or be arranged in array. The second part 206 include sidewalls 206A surrounding the first parts 204, and sidewalls 206B between the first and second portions 204A and 204B, wherein the sidewalls 206A and 206B are extended vertically.

In FIG. 4B, the first part 304 includes a first portion 304A and a second portion 304B surrounded by the first portion 304A. Specifically, the first and second portions 304A and 304B are joined together and surrounded by the second part 306. The first portion 304A includes inclined planar surfaces, and the second portion 304B is a horizontal planar surface. Thus, the normal vectors of the first portion 304A are not parallel to those of the second portion 304B. As used herein, a “normal vector” of a surface (or an object) is a vector perpendicular thereto.

FIG. 4C depicts an example of the back bezel of FIG. 4B, wherein the second portion 304B′ is rectangular. The first portion 304A′ includes four inclined planar surfaces extending towards the second portion 304B′. The second part 306′ surrounds the first portion 304A′ and the second portion 304B′.

FIG. 4D depicts another example of the back bezel of FIG. 4B, wherein the second portion 304B″ is elliptical. The first portion 304A″ includes four inclined planar surfaces extending towards the second portion 304B″. The second part 306″ surrounds the first portion 304A″ and the second portion 304B″.

Referring to FIG. 4E, the first part 404, as compared to the first part 304′ of FIG. 4C, further includes a third portion 404C. The first portion 404A is surrounded by the third portion 404C. Both of the first portion 404A and the third portion 404C include inclined planar surfaces. Each inclined planar surface of the first portion 404A and the adjacent inclined planar surface of the third portion 404C are not parallel. The second portion 404B is a horizontal planar surface. Thus, the normal vectors of the first, second, and third portions are not parallel to each other.

Referring to FIG. 4F, the first part 504, as compared to the first part 304′ of FIG. 4C, further includes a third portion 504C. The first portion 504A is surrounded by the third portion 504C. Note that the second portion 504B and the third portion 504C are horizontal planar surfaces and the first portion 504A includes inclined planar surfaces. The second and third portions 504B and 504C are arranged at different levels.

Referring to FIG. 4G, the first part 604, as compared to the first part 404 of FIG. 4E, further includes a fourth portion 604D, a fifth portion 604E, and a sixth portion 604F. The third portion 604C is surrounded by the fourth portion 604D, the fourth portion 604D is surrounded by the fifth portion 604E, and the fifth portion 604E is surrounded by the sixth portion 604F. Furthermore, the second portion 604B is a horizontal planar surface. The other portions 604A, 604C, 604D, 604E, and 604F include inclined planar surfaces, wherein each inclined planar surface and its adjacent inclined planar surface on different portions are not parallel. Thus, the normal vectors of the portions 604A, 604C, 604D, 604E, and 604F are not parallel.

Referring to FIG. 4H, the first part 704 includes a subpart I and a subpart II. The subpart I and the subpart II have respective portions including, for example, a first portion 704A, a second portion 704B, a third portion 704C, and a fourth portion 704D.

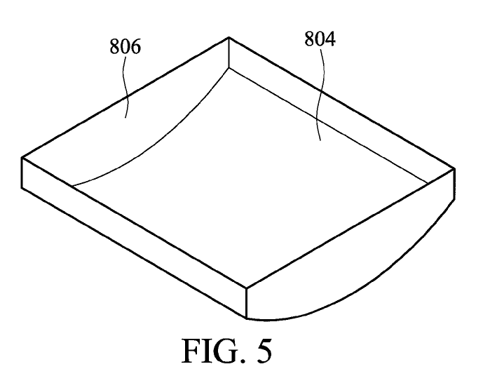

Referring to FIG. 5, the first part 804 includes a curved surface with a plurality of spot light sources (not shown) mounted thereon. Thus, the locations of the spot light sources along the thickness of the back bezel are not the same. It is noted that the first part 804 in the figure includes a continuous curved surface. However, the first part may include separated curved surfaces.

In the invention, the first part of the back bezel is used for mounting light sources. However, all of the planar surfaces and curved surfaces of the first part are not necessarily provided with light sources. Furthermore, the spot light sources may be distributed at the planar surfaces and/or the curved surfaces in different densities in accordance with design requirements. As shown in FIG. 3, for example, the spot light sources on the second portion 104B are distributed more densely than those on the first portion 104A.

Referring again to FIG. 4C, a plurality of spot light sources (not shown) may be provided on the first portion 304A′. The spot light sources may be provided on every inclined planar surfaces of the first portion 304A′, or only two inclined planar surfaces opposite to or adjacent to each other. Furthermore, the inclined planar surfaces and the curved surfaces of the first part without spot light sources provided thereon can be reduced in area.

While the invention has been described by way of example and in terms of preferred embodiments, it is to be understood that the invention is not limited thereto. Rather, it is intended to cover various modifications and similar arrangements. Therefore, the scope of the appended claims should be accorded the broadest interpretation so as to encompass all such modifications and similar arrangements.

What is claimed is:

1. A backlight module, comprising:
a back bezel;
a first spot light source and a second spot light source disposed on the back bezel at different locations along a thickness of the backlight module; and
a diffuser plate disposed above the back bezel, the first spot light source, and the second spot light source.

2. The backlight module as claimed in claim 1, wherein the back bezel comprises a curved surface.

3. The backlight module as claimed in claim 2, wherein the back bezel comprises a planar surface.

4. The backlight module as claimed in claim 1, wherein the back bezel comprises a first portion and a second portion, each of which comprises a planar surface.

5. The backlight module as claimed in claim 4, wherein a normal vector of the first portion is not parallel to that of the second portion.

6. The backlight module as claimed in claim 5, wherein the planar surface of the first portion is inclined.

7. The backlight module as claimed in claim 5, wherein the planar surface of the second portion is inclined.

8. The backlight module as claimed in claim 4, wherein the planar surfaces of the first portion and the second portion are arranged at different levels.

9. The backlight module as claimed in claim 4, wherein the back bezel further comprises a third portion having a horizontal planar surface.

10. The backlight module as claimed in claim 9, wherein the third portion comprises an inclined planar surface.

11. The backlight module as claimed in claim 8, wherein the planar surface of the second portion is higher than that of the first portion.

12. The backlight module as claimed in claim 8, wherein the planar surface of the second portion is lower than that of the first portion.

13. The backlight module as claimed in claim 8, wherein the second portion is surrounded by the first portion.

14. The backlight module as claimed in claim 8, wherein the first portion is surrounded by the second portion.

15. The backlight module as claimed in claim 8, wherein the back bezel comprises a plurality of first portions and a plurality of second portions arranged alternately.

16. The backlight module as claimed in claim 8, wherein the back bezel comprises a plurality of first portions and a plurality of second portions arranged in array.

17. The backlight module as claimed in claim 1, wherein the first and second spot light sources are light emitting diodes.

18. The backlight module as claimed in claim 17, wherein radiation patterns of the first and second spot light sources are different.

19. A flat panel display, comprising:
a display panel;
a backlight module as claimed in claim 1, disposed under the display panel; and
a shell surrounding the display panel and the backlight module.

20. A backlight module, comprising:
a back bezel;
a first spot light source and a second spot light source disposed on the back bezel, wherein an optical axis of the first spot light source is not parallel to that of the second spot light source; and
a diffuser plate disposed above the back bezel, the first spot light source, and the second spot light source.

21. The backlight module as claimed in claim 20, wherein the back bezel comprises a curved surface.

22. The backlight module as claimed in claim 20, wherein the back bezel comprises a first portion and a second portion, each of which comprises a planar surface, and a normal vector of the first portion is not parallel to that of the second portion, the first spot light source is disposed on the first portion, and the second spot light source is disposed on the second portion.

23. A backlight module, comprising:
a back bezel;
a plurality of first spot light sources disposed on the back bezel;
a plurality of second spot light sources also disposed on the back bezel, wherein locations of the second spot light sources are different from those of the first spot light sources along a thickness of the backlight module, and the first spot light sources and the second spot light sources are distributed in different densities; and
a diffuser plate disposed above the back bezel, the first spot light sources, and the second spot light sources.

24. A backlight module, comprising:
a back bezel;
a plurality of first spot light sources disposed on the back bezel;
a plurality of second spot light sources also disposed on the back bezel, wherein axes of the second spot light sources are not parallel to those of the first spot light sources, and the first spot light sources and the second spot light sources are distributed in different densities; and
a diffuser plate disposed above the back bezel, the first spot light sources, and the second spot light sources.
